(19) United States
(12) Patent Application Publication
(10) Pub. No.: US 2011/0124413 A1
(43) Pub. Date: May 26, 2011

(54) HAPTIC-SIMULATION HOME-VIDEO GAME

(76) Inventor: Ofer LEVANON, Kfar Saba (IL)

(21) Appl. No.: 12/624,145

(22) Filed: Nov. 23, 2009

(51) Int. Cl. A63F 9/24; H04B 3/36; G06F 3/033; A63F 13/00

(52) U.S. Cl. 463/36; 340/407.1; 345/161; 463/30

(57) ABSTRACT

A home-video game equipped with a haptic-simulation seat configured to operate on gaming data generated by the user and gaming-feedback data utilized by a force-feedback gaming console.

### FIELD AND BACKGROUND OF THE INVENTION

The present invention relates to home video games, and, in particular is concerned with a haptic-simulation seat for a game user.

It is know that home video-games are moving towards providing users with a more realistic gaming experiences by way of multiple forms of feedback that appeal to as many of the senses as possible. Visual and audio simulations in video games have been augmented by haptic simulations. Sony “Playstation” and Nintendo “64 Rumble Pack” 64” provide haptic feedback in the form of vibrations when users fire a gun or are hit by enemy fire. Microsoft's “Force Feedback Joystick” and “Immersion One” provide more sophisticated forms of haptic simulation via a force-feedback joystick and Logitech's “G25 and G27 force-feedback “Racing Wheel”. Although these products provide haptic simulation by way of a force-feedback joysticks and racing wheels, they provide very limited, if it all, haptic simulation of the seat used by the user. U.S. Pat. Nos. 6,431,989 6,152,828 and 5,951,018 teach a gaming systems providing haptic simulation for a user's seat; however, these systems utilize specialized equipment and because of their sophistication are expensive and unsuitable for the average home user.

Therefore, it would be advantageous for home-video games to be equipped with haptic-simulation seats providing haptic simulation of the user's gaming activities and the gaming conditions resulting from those activities.

### SUMMARY OF THE INVENTION

The present invention is a home-video game including a haptic-simulation seat operative in accordance with user gaming data generated by a forced-feedback gaming console and also gaming-feedback data representing resulting gaming conditions utilized by the force-feedback gaming console.

According to the teachings of the present invention there is provided haptic-simulation, home-video game comprising: a) a gaming-system including i) a game processor configured to generate gaming-feedback data based on a video-game user's gaming activities; ii) a display screen operative to display the gaming-feedback data generated by the game processor; iii) a force-feedback gaming-console including a first data-to-motion converter, the force-feedback gaming-console configured to generate haptic simulations of gaming conditions displayed on the display screen based on the gaming-feedback data received by the first data-to-motion converter; and b) a haptic-simulation seat including a second data-to-motion converter, the haptic-simulation seat being configured to generate haptic simulations based on the gaming-feedback data flow utilized by the force-feedback gaming-console.

According to a further feature of the present invention the haptic-simulation seat is configured to generate haptic-simulations in accordance with the user's gaming activities by way of a data flow path configured to transfer gaming data generated by the force-feedback gaming console to the second data-to-motion converter.

According to a further feature of the present invention the haptic-simulation, home-video game is implemented as a driving game.

According to a further feature of the present invention the haptic-simulation, home-video game of claim 1, wherein the haptic-simulation is at least one motion chosen from the group of rotating, vibrating, rocking and tilting.

According to a further feature of the present invention the tilting is in at least one direction chosen from the group consisting of forwards, backwards, and sideways.

According to a further feature of the present invention the gaming-console includes at least one user-interface chosen from the group consisting of steering-wheel, joy stick, shift-mechanism and pedal.

According to a further feature of the present invention the pedal includes at least of one pedal chosen from the group consisting of a brake pedal, acceleration pedal, and clutch pedal.

There is also provided according to the teachings of the present invention method method for providing haptic-simulation data to a haptic-simulation seat used by a video game user comprising: (a) providing a video-gaming system including: i) a game processor operative to generate gaming-feedback data based on gaming activities of the video game user; ii) a display screen; iii) a force-feedback gaming-console that includes a first data-to-motion converter, the force-feedback gaming-console being configured to generate haptic-simulations of gaming-conditions presented on the display screen based on the gaming feedback data received by the first data-to-motion converter; (b) providing a haptic-simulation seat including a second data-to-motion converter, the haptic-simulation seat being configured to also generate haptic-simulations of the gaming activities appearing on the display screen; and (c) establishing a path for data flow of the gaming-feedback data between the video-gaming system and the haptic-simulation seat so as to enable the haptic-simulation seat to generate the haptic simulations based on the gaming feedback data received by the first data-to-motion converter.

According to a further feature of the present invention the second data-to-motion converter of the haptic-simulation seat receiving gaming data generated by the user on the the force-feedback gaming console so that the seat haptically simulates the gaming activities.

According to a further feature of the present invention the establishing a path for data flow of the gaming-feedback data between the video-gaming system and the haptic-simulation seat includes plugging a detachable data flow line into a data port disposed in the video-gaming system.

According to a further feature of the present invention the video gaming system is implemented as a driving game.

According to a further feature of the present invention the generation of haptic-simulations includes motion chosen from the group consisting of rotating, vibrating, rocking and tilting.

According to a further feature of the present invention the tilting is in at at least one of directions chosen from the group consisting of forwards, backwards, and sideways.

According to a further feature of the present invention the generation of haptic-simulations includes tilting in any one or combination of directions chosen from the group consisting of forwards, backwards, and sideways.

According to a further feature of the present invention the generation of haptic-simulations of the haptic-simulation seat is further based on receiving data from at least one mechanism included in the gaming-console chosen from the group consisting of a steering wheel, joystick, acceleration pedal, braking pedal, clutch pedal, and shifting mechanism.

There is also provided according to the teachings of the present invention a method for providing haptic-simulation data to a haptic-simulation seat used by a video game user comprising: (a) providing a video-game including: a force-feedback gaming-console configured to generate gaming data of a user using the console; (b) providing a haptic-simulation seat including a data-to-motion converter configured to generate haptic-simulations of the gaming activities of the video-game user based on the gaming data; and (c) establishing a path for data flow of the gaming-data between the force-feedback gaming console and the haptic-simulation seat so as to enable the haptic-simulation seat to generate the haptic simulations based on the gaming data received by the data-to-motion converter.

According to a further feature of the present invention the generation of haptic-simulations of the haptic-simulation seat is further based on receiving data from at least one mechanism included in the gaming-console chosen from the group consisting of a steering wheel, joystick, acceleration pedal, braking pedal, clutch pedal, and shifting mechanism.

There is a also provided according to the teachings of the present invention a haptic-simulation, home-video game comprising: a) a force-feedback gaming-console configured to generate gaming data representing gaming activities of a user using the console; and b) a haptic-simulation seat configured to generate haptic simulations of the gaming actives of the user using the force-feedback gaming console based on the gaming data generated by the force feedback gaming console.

According to a further feature of the present invention the gaming-console includes at least one user-interface chosen from the group consisting of steering-wheel, joy stick, shift-mechanism and pedal.

According to a further feature of the present invention the pedal includes at least of one pedal chosen from the group consisting of a brake pedal, acceleration pedal, and clutch pedal.

### BRIEF DESCRIPTION OF THE DRAWINGS

The invention is herein described, by way of example only, with reference to the accompanying drawings:

FIG. 1 is a schematic, side view of home-video game its various components.

FIG. 2 is a schematic, side view of the haptic-simulation seat depicting the vertical movement of the chair as one form of haptic simulation.

FIGS. 3 and 4 a schematic side view of the haptic-simulation seat depicting forwards and backwards tilting motion as an additional form of haptic simulation.

FIGS. 5 and 6 are schematic, back views of the haptic-simulation seat depicting side-way tilting as an additional form of haptic simulation.

FIG. 7 is a second implementation of the system of FIG. 1 employing a wireless data link between the game processor and the haptic-simulation seat.

FIG. 8 is a flow chart depicting a gaming-feedback data flow configuration.

FIG. 9 is a flow chart depicting a gaming-feedback and a gaming-data flow configuration.

### DESCRIPTION OF THE PREFERRED EMBODIMENTS

The present invention is a home-video game equipped with a haptic-simulation seat configured to operate on gaming data generated by the user and gaming feedback data used by a force feedback gaming console.

By way of introduction following is a list of definitions of terms used throughout the document:
“Haptic simulation” refers to a form of simulation that interfaces with the user by the sense of touch by applying forces, vibrations and/or motions a user.
“Force-feedback gaming console” refers to a user interface supplying a force as feedback to a user's input.

The current home-video game is a video-gaming system in operative connection with a haptic-simulation seat on which the user sits while playing the game. The relevant elements, their operative interrelationship, and their various implementations may be better understood with reference to the following figures and the accompanying description.

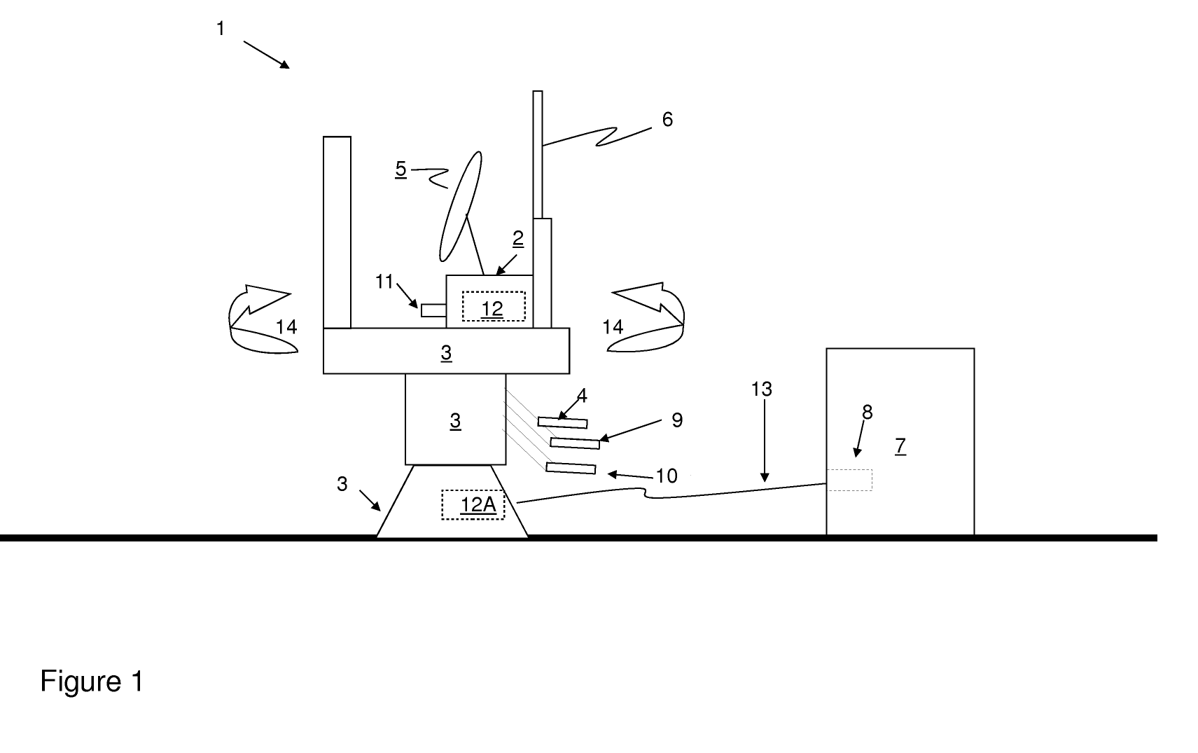

FIG. 1 depicts a schematic, side-view of home-video game 1 including force-feedback gaming console 2, haptic-simulation seat 3, steering wheel 5, display screen 6, game processor 7, data port 8, brake, accelerator 9, accelerator pedal 10, clutch pedal 4, shift mechanism 11, data-to-motion converters 12, and data cable 13.

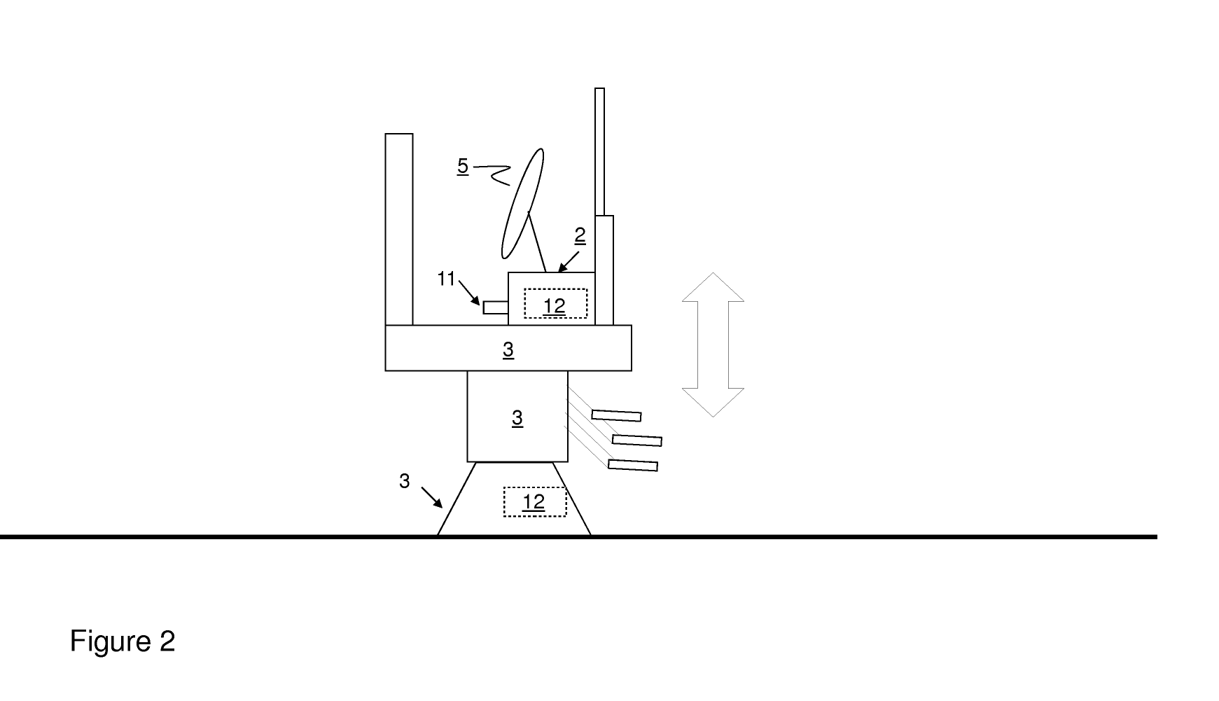

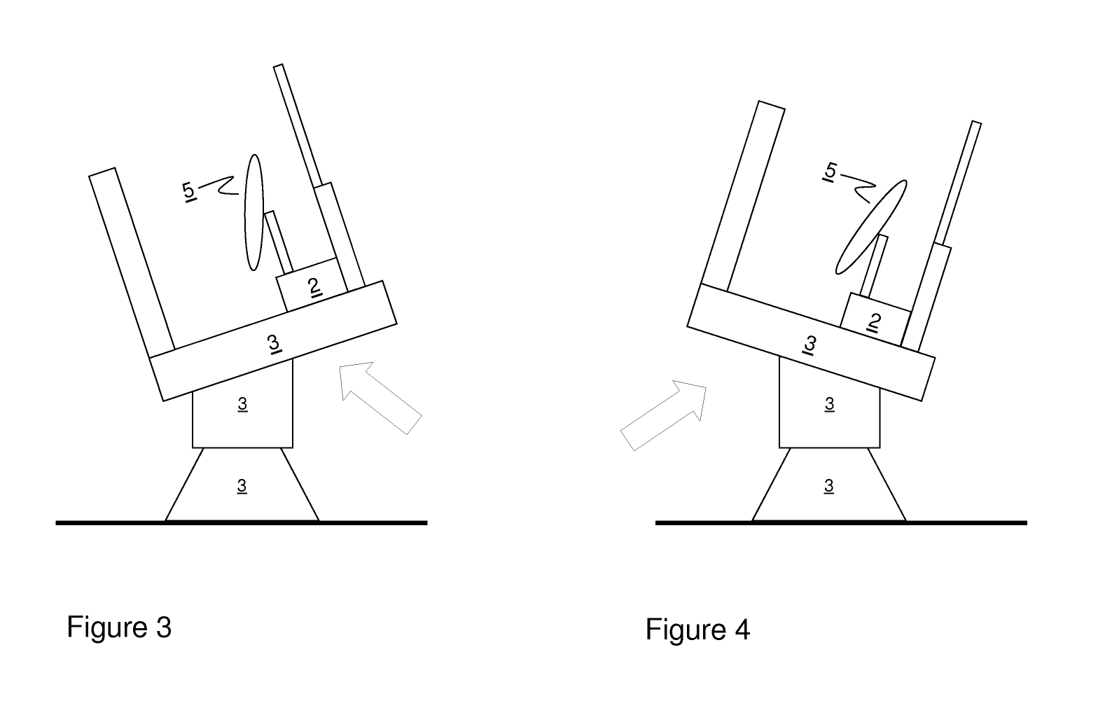

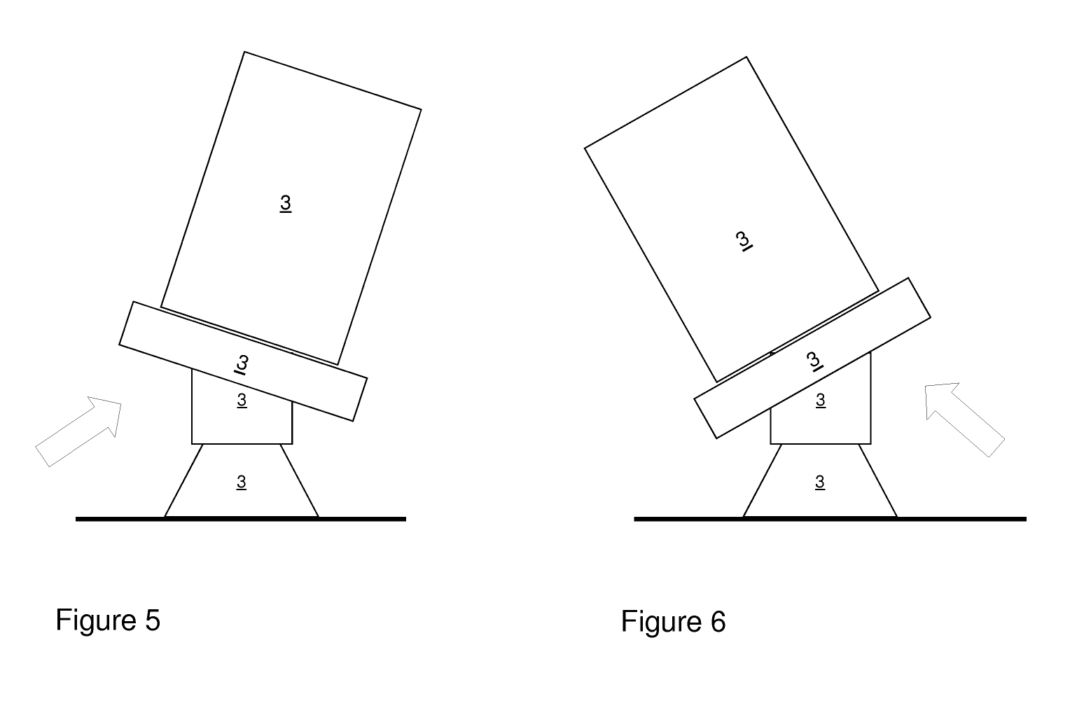

Haptic-simulation seat 3 include various motion generator mechanisms configured to rotate seat 3 in a horizontal plane, vibrate seat 3 vertically or horizontally, or tilt seat 3 forwards, backwards, sideways, rock or move seat 3 in any combination of these motions as shown in FIGS. 2-6. In a non-limiting exemplary embodiment the motion generator mechanisms are implemented by way of mechanism are motor and gear/pulley arrangements, hydraulic, pneumatic arrangements or any other motion producing arrangement know to those skilled in the art. The motion generator mechanisms move seat 3 in accordance with gaming data received by data-to-motion converter 12A. Force feedback-gaming console 2 includes various user interfaces such as steering wheel 5, brake, acceleration, and clutch pedals designated 9, 10 and 13 respectively, and in a variant embodiment, joy stick 17 (FIG. 17). Through these interfaces the user responds to gaining conditions generated by game processor 7. As is known in the art, game processor 7 generates gaming conditions in accordance with a gaming program loaded into a memory (not shown). In an exemplary non-limiting embodiment game processor 7 is implemented by way of a personal home computer as shown in FIG. 1; however, it should be noted that game processor 7 implemented as an online server or as a processor integrated into force-feedback gaming console 2 or any other data processing device are included within the scope of the current invention.

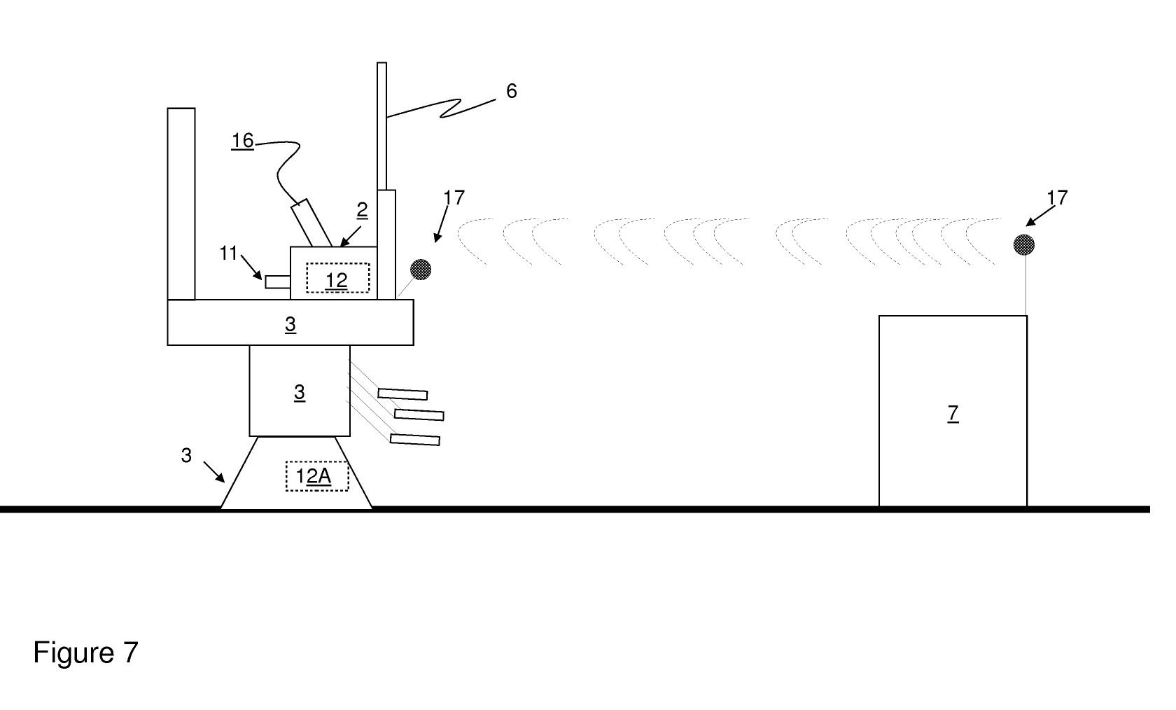

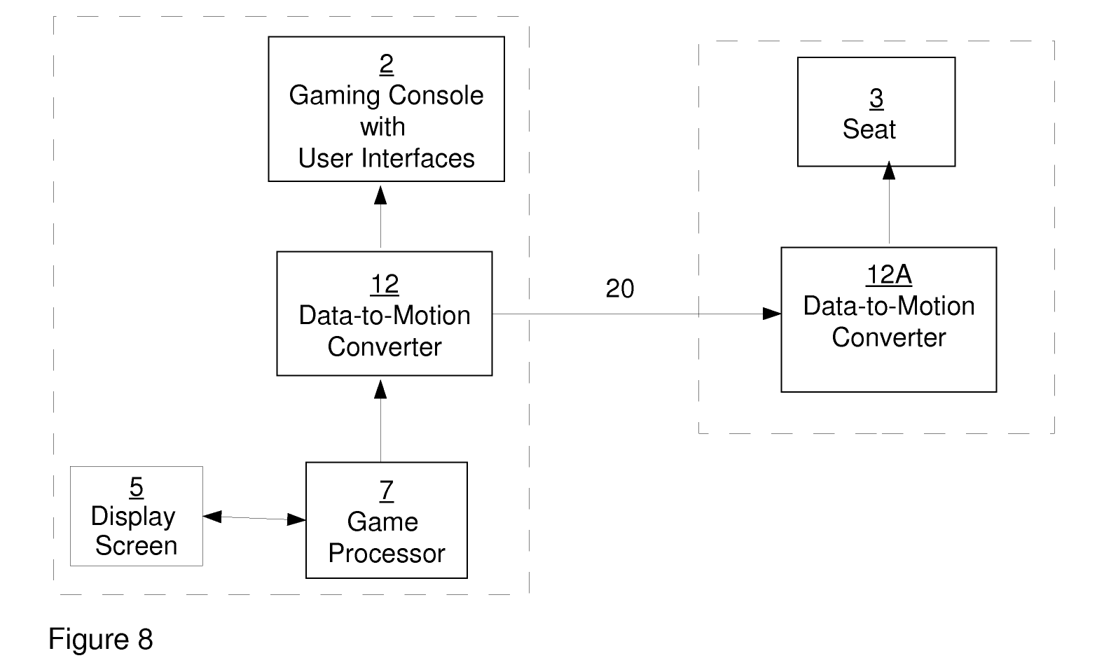

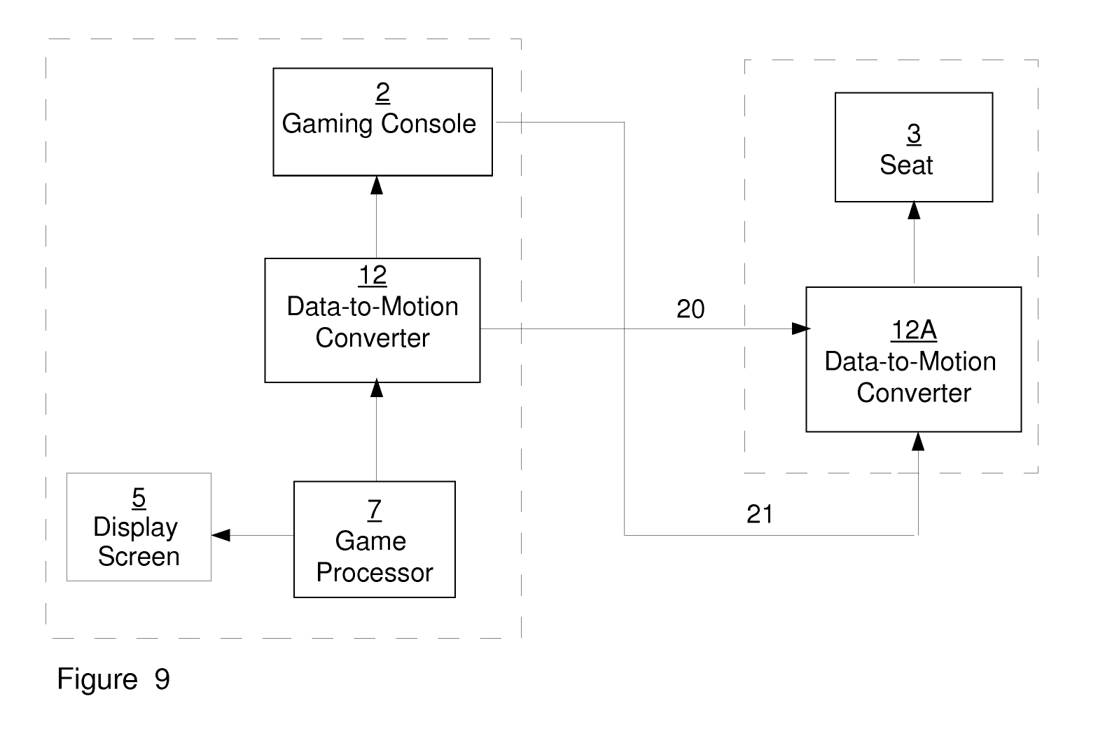

The various forms of user input is translated into gaming data 21 by way of a motion-to-data converter (not shown) and processed by processor 7 to generate gaming feedback data 20 (FIGS. 8 and 9) representing new gaming conditions. These gaming conditions conditions are displayed on display screen 6 and gaming feedback data 20 serves as the basis for the force-feedback effects generated by force-feedback gaming console 2 by way of data-to-motion converter 12. The current invention utilizes this gaming feedback data 20 to create the haptic-simulations of haptic simulation seat 3. By way of example, gaming feedback data 20 responsible for vibrating steering wheel 5 is also responsible for vibrating seat 3 a second data-to-motion converter 12A. Gaming feedback data 20 responsible for applying a torque to steering wheel 5 is also directed to data-to-motion converter 12A to generate a corresponding haptic effect in seat 3. It should be noted that the particular nature of the haptic-simulation of seat 3 is a function of both the nature of gaming feedback data 20, FIG. 8, and the motion-generator mechanism configuration. The same gaming feedback data 20 responsible for the force feedback effects of gaming console 2 is also responsible for a wide variety of haptic simulations of seat 3. By way of example, gaming feedback data 20 responsible for applying a torque to steering wheel 5 can also initiate a corresponding rotation in the same direction, a reverse rotation, tilting or even rotating seat 3 while tilting depending on the configuration of various motor, gear, and/or pulley arrangements known to those skilled in the art. All forms of haptic simulation emulating from gaming feedback data 20 also responsible for the force feedback effects of gaming console 2 are included within the scope of the present invention. Furthermore, configurations in which haptic seat simulations are generated from a plurality of data-to-motion converters 12A receiving gaming feedback data 20 are also included in the scope of the present invention. FIG. 8 depicts the above-described gaming feedback data flow path. It should be noted that a gaming-feedback flow path between gaming system and data-to-motion converter 12A of seat 3 is implemented as data cable 13, FIG. 1, in an exemplary embodiment; however, FIG. 7 depicts a gaming-feedback data flow path implemented by way of a wireless connection 17 also included within the scope of the current invention. Furthermore, the gaming-feedback data flow path implemented by way of a fixed data flow path or by way of a detachable cable configured to plug into port 8 is also included within the scope of the current invention.

The current invention teaches another feature in which the gaming activities of the user are simulated haptically in seat 3. By way of several examples, a user turns steering wheel 5 and the seat 3 accordingly rotates in the opposite direction so as to simulate the effects of driving. Likewise, a user applies pressure to brake pedal 9 and seat 3 synchronously tilts forwards or when the user applies pressure to acceleration pedal 10 seat 3 responds by tilting backwards accordingly. This functionality is accomplished by directing gaming data 21 generated by gaming console 2 to data-to-motion converter 12A in addition to directing it to game processor 7 as shown in FIG. 9.

It will be appreciated that the above descriptions are intended only to serve as examples, and that many other possible embodiments are within the scope of the present invention as defined in the appended claims.

What is claimed is:

1. A haptic-simulation, home-video game comprising:
a) a gaming-system including
i) a game processor configured to generate gaming-feedback data based on a video-game user's gaming activities;
ii) a display screen operative to display said gaming-feedback data generated by said game processor;
iii) a force-feedback gaming-console including a first data-to-motion converter, said force-feedback gaming-console configured to generate haptic simulations of gaming conditions displayed on said display screen based on said gaming-feedback data received by said first data-to-motion converter; and
b) a haptic-simulation seat including a second data-to-motion converter, said haptic-simulation seat being configured to generate haptic simulations based on said gaming-feedback data flow utilized by said force-feedback gaming-console.

2. The haptic-simulation, home-video game of claim 1, wherein said haptic-simulation seat is configured to generate haptic-simulations in accordance with the user's gaming activities by way of a data flow path configured to transfer gaming data generated by said force-feedback gaming console to said second data-to-motion converter.

3. The haptic-simulation, home-video game of claim 1 is implemented as a driving game.

4. The haptic-simulation, home-video game of claim 1, wherein said haptic-simulation is at least one motion chosen from the group of rotating, vibrating, rocking and tilting.

5. The haptic-simulation, home-video game of claim 4, wherein said tilting is in at least one direction chosen from the group consisting of forwards, backwards, and sideways.

6. The haptic-simulation, home-video game of claim 4, wherein said gaming-console includes at least one user-interface chosen from the group consisting of steering-wheel, joy stick, shift-mechanism and pedal.

7. The haptic-simulation, home-video game of claim 6, wherein said pedal includes at least of one pedal chosen from the group consisting of a brake pedal, acceleration pedal, and clutch pedal.

8. A method for providing haptic-simulation data to a haptic-simulation seat used by a video game user comprising:
(a) providing a video-gaming system including:
i) a game processor operative to generate gaming-feedback data based on gaming activities of the video game user;
ii) a display screen;
iii) a force-feedback gaming-console that includes a first data-to-motion converter, said force-feedback gaming-console being configured to generate haptic-simulations of gaming-conditions presented on said display screen based on said gaming feedback data received by said first data-to-motion converter;
(b) providing a haptic-simulation seat including a second data-to-motion converter, said haptic-simulation seat being configured to also generate haptic-simulations of said gaming activities appearing on said display screen; and
(c) establishing a path for data flow of said gaming-feedback data between said video-gaming system and said haptic-simulation seat so as to enable said haptic-simulation seat to generate said haptic simulations based on said gaming feedback data received by said first data-to-motion converter.

9. The method of providing haptic-simulation data to a haptic-simulation seat used by a video-game user of claim 8, further comprising said second data-to-motion converter of said haptic-simulation seat receiving gaming data generated by the user on said said force-feedback gaming console so that said seat haptically simulates said gaming activities.

10. The method of providing haptic-simulation data to a haptic-simulation seat of claim 12, wherein said establishing a path for data flow of said gaming-feedback data between said video-gaming system and said haptic-simulation seat includes plugging a detachable data flow line into a data port disposed in said video-gaming system.

11. The method for providing haptic simulation data to a haptic-simulation seat of claim 8, wherein said video gaming system is implemented as a driving game.

12. The method for providing haptic simulation data to a haptic-simulation seat of claim 8, wherein said generation of haptic-simulations includes motion chosen from the group consisting of rotating, vibrating, rocking and tilting.

13. The method for providing haptic-simulation data to a haptic-simulation seat of claim 12, wherein said tilting is in at at least one of directions chosen from the group consisting of forwards, backwards, and sideways.

14. The method for providing haptic-simulation data to a haptic-simulation seat of claim 12, wherein said generation of haptic-simulations includes tilting in any one or combination of directions chosen from the group consisting of forwards, backwards, and sideways.

15. The method for providing haptic-simulation data to a haptic-simulation seat of claim 8, wherein said generation of haptic-simulations of said haptic-simulation seat is further based on receiving data from at least one mechanism included in said gaming-console chosen from the group consisting of a steering wheel, joystick, acceleration pedal, braking pedal, clutch pedal, and shifting mechanism.

16. A method for providing haptic-simulation data to a haptic-simulation seat used by a video game user comprising:
(a) providing a video-game including:
a force-feedback gaming-console configured to generate gaming data of a user using said console;
(b) providing a haptic-simulation seat including a data-to-motion converter configured to generate haptic-simulations of said gaming activities of the video-game user based on said gaming data; and
(c) establishing a path for data flow of said gaming-data between said force-feedback gaming console and said haptic-simulation seat so as to enable said haptic-simulation seat to generate said haptic simulations based on said gaming data received by said data-to-motion converter.

17. The method for providing haptic-simulation data to a haptic-simulation seat of claim 8, wherein said generation of haptic-simulations of said haptic-simulation seat is further based on receiving data from at least one mechanism included in said gaming-console chosen from the group consisting of a steering wheel, joystick, acceleration pedal, braking pedal, clutch pedal, and shifting mechanism.

18. A haptic-simulation, home-video game comprising:
a) a force-feedback gaming-console configured to generate gaming data representing gaming activities of a user using said console; and
b) a haptic-simulation seat configured to generate haptic simulations of said gaming actives of the user using said force-feedback gaming console based on said gaming data generated by said force feedback gaming console.

19. The haptic-simulation, home-video game of claim 18, wherein said gaming-console includes at least one user-interface chosen from the group consisting of steering-wheel, joy stick, shift-mechanism and pedal.

20. The haptic-simulation, home-video game of claim 19, wherein said pedal includes at least of one pedal chosen from the group consisting of a brake pedal, acceleration pedal, and clutch pedal.
